(19) United States
(12) Patent Application Publication
(10) Pub. No.: US 2007/0144975 A1
(43) Pub. Date: Jun. 28, 2007

(54) APPARATUS, METHOD AND SYSTEM OF TREATMENT OF ARSENIC AND OTHER IMPURITIES IN GROUND WATER

(75) Inventors: Gregory P. Miller, Socorro, NM (US); Neil Mansuy, Kansas City, MO (US)

Correspondence Address: HUNTON & WILLIAMS/NEW YORK;INTELLECTUAL PROPERTY DEPT., 1900 K STREET, N.W., SUITE 1200, WASHINGTON, DC, 20006-1109, US

(73) Assignee: Subsurface Technologies, Inc., Rock Tavern, NY (US)

(21) Appl. No.: 11/683,685

(22) Filed: Mar. 8, 2007

Related U.S. Application Data
(63) Continuation of application No. 10/550,071.
(60) Provisional application No. 60/456,669, filed on Mar. 21, 2003.
(60) Provisional application No. 60/456,876, filed on Mar. 21, 2003.

(51) Int. Cl. B01J 39/00

(52) U.S. Cl. 210/667

(57) ABSTRACT

The invention uses apparatus, methods or systems, e.g., fine pore diffusers (18), to saturate ground water with a gas, preferably oxygen, but also possibly methane, air, inert or noble gasses and/or carbon dioxide. The pore diffusers (18) can be in a ring of aeration injection wells (16) in a large concentric ring around a production well. By increasing the dissolved oxygen level in the ground water, undesirable constituents such as iron or arsenic are lowered in concentration. Methods can be employed to optimize the ground water treatment by injection of other substances, such as iron, as well as predict, model, design, monitor and maintain the treatment process.

### CROSS REFERENCE TO RELATED APPLICATIONS

This application is a continuation of U.S. patent application Ser. No. 10/550,071 filed Sep. 21, 2005, entitled Apparatus, Method and System Of Treatment Of Arsenic And Other Impurities In Ground Water, which claims priority of PCT/US2004/08712 filed Mar. 22, 2004 and U.S. provisional patent application Ser. No. 60/456,669 filed Mar 21, 2003 and U.S. provisional patent application Ser. No. 60/456,876 filed Mar. 21, 2003 and the complete content of these applications is incorporated by reference.

### FIELD OF THE INVENTION

The present invention relates methods for altering ground water chemistry and to subsurface treatments for removal of undesirable ground water constituents such as, for example, iron, manganese, arsenic and other impurities.

### BACKGROUND OF THE INVENTION

In the past, water requiring treatment for removal of iron and manganese was treated in a water treatment plant by adding oxygen to the water. This caused precipitation of impurities which were filtered out to leave purified water. The precipitates had to be disposed of. In the past, water requiring treatment for removal of arsenic was treated by removal using filtration media or chemical precipitation. This caused production of arsenic-bearing waste products.

Iron and manganese are among the most common contaminants found in groundwater. Iron and manganese concentrations are regulated by State and Federal Secondary Standards for aesthetic parameters in drinking water because of objectionable taste and displeasing and costly staining and encrustations. In 2001, the United States Environmental Protection Agency lowered its maximum contaminant level (MCL) for arsenic from 0.050 to 0.010 mg/L (ppb) effective in January 2006. The national cost for treating drinking water to comply with federal arsenic concentration standards is estimated to be in the range of $250 million to $400 million annually. Many small community water systems using aquifers as a water source will have a difficult time implementing treatment, primarily because of cost.

Ground water flows naturally from one point to another because of pressure gradients. It can also flow under the influence of pressure gradients caused by the injection or withdrawal of fluids from aquifers. When ground water flows by the screened section of a non-pumping well, flow converges on the developed portion of the aquifer and the well screen, a portion of the flow passes through the well, then diverging and rejoining the ground water flow on the down gradient side of the well. When flow velocities are slow as compared to chemical gradients, diffusion of in-well-bore chemistry will also alter aquifer chemistry. Continuous alteration of water chemistry in and around the well bore results in alteration of ground water chemistry down gradient of the well(s).

Iron and manganese are extremely common elements in geomedia and groundwater. Dissolved iron exists aquifers predominantly in the Fe²⁺ oxidation state. Dissolved manganese is almost always present in the Mn²⁺ form. These ions cause the objectionable properties of iron and manganese in water supplies. Fe²⁺ and Mn²⁺ generally remain dissolved in ground water until precipitated in the presence of oxygen. Precipitates include oxides (Fe₂O₃, MnO₂), oxyhydroxides (FeOOH, MnOOH) or hydroxides (Fe(OH)₃, Mn(OH)₂). The iron and manganese oxidation states are dependant on the oxidation-reduction (redox) state of the aquifer. The redox condition of an aquifer can be manipulated by controlling the concentration of dissolved oxygen.

Arsenic is found in all geological environments with normal concentrations ranging from 1 to 12 ppm in rocks, approximately 7.5 ppm in aquifer materials and 2 ppb in typical ground water. Most of the arsenic found in nature is inorganic. However, arsenic is also involved in cellular processes in animals and plants, producing low levels of organic arsenic compounds. Arsenic is generally present in water and sediments in the As³⁺ and As⁵⁺ oxidation states. These different forms of arsenic each have different toxicities and environmental pathways. As³⁺ and As⁵⁺ each has several pH dependent forms. The most common inorganic aqueous species in natural waters at pH 6-9 are H₂AsO₄⁻, HAsO₄²⁻ and H₃AsO₃⁰. The inorganic species dominate natural systems, however, a number of organic species may be present at trace levels.

The oxidation state of arsenic has a significant effect on its mobility. The most common As³⁺ species in natural waters, H₃AsO₃⁰, is uncharged under the same pH conditions that As⁵⁺ complexes are negatively charged. Uncharged species react less with surfaces than charged species. When As³⁺ is oxidized to As⁵⁺, the arsenic is less mobile because charged As⁵⁺ species are attracted to charged surfaces. The two most common As⁵⁺ species in natural waters are H₂AsO₄⁻ and HAsO₄²⁻.

Adsorption of arsenic (As) onto iron oxides, hydroxides, and oxyhydroxides (FeOₓ) is the basis for many above ground treatment technologies. These treatment processes are among the most efficient and least costly arsenic removal methods known, and generally produce chemically stable waste products. (More costly arsenic removal methods include reverse osmosis, ultrafiltration and ion exchange.) Arsenic is removed from water by either co-precipitation with FeOₓ or sorption to FeOₓ via a surface complexation process. These treatment technologies require high capital costs and high annual costs related to media replacement, produce large amounts of As—FeOₓ residuals that must be disposed of, require training and chemical management, and require construction of a plant proximal to municipal well fields. Therefore, these conventional ground water arsenic treatment systems and techniques represent a tremendous resource burden in terms of money, labor and on-going maintenance. A primary reason for the high cost is the suggested technique of drawing water up to the ground, processing it with above ground equipment, and then replacing the water back into the ground. A substantial system of pumps, conduits, processing equipment and other hardware is required.

There is a real need in the art for a method, apparatus and system for effective treatment of arsenic in ground water that improves over and is less costly than current technologies, particularly in light of new stricter regulations relating to drinking water. Similar needs exist for treatment of other in-ground compounds or substances such as iron (Fe) and manganese (Mn). Elimination of above-ground treatment inefficiencies would be desirable.

A flexible, adaptable, effective, relatively economical method and system for meeting the stricter requirements would be desirable, as would methods and systems to predict, design, monitor, and maintain effective in situ treatment of ground water for these types of substances.

Systems are known which attempt to conduct in situ treatment of ground water.

For example, Billings et al., in U.S. Pat. No. 5,221,159, U.S. Pat. No. 5,277,518 and U.S. Pat. No. 5,472,294 describes a ground water remediation system where pressurized air is injected into an aquifer via an injection well. In addition, microorganisms that feed on the targeted contaminant are introduced into the subsurface. Volatized contaminants, byproducts and air are then forced up into a venting well, or through the soil into the atmosphere. The venting well may be attached to a vacuum pump. No water is taken from the ground. This system is strictly for contaminant remediation, not for producing drinking water. Billings et al. recognize that heavy metals such as iron, manganese, nickel, cobalt and chromium are all precipitated into insoluble oxides and hydroxides at a high oxygen content of ground water. However, no mention of arsenic is made.

Carpenter, in U.S. Pat. No. 6,254,786, teaches the oxygenation of ground water to convert soluble iron and manganese impurities into insoluble metal oxides. Contaminated ground water is passed through porous treatment media through which a flow of oxygenated gas is directed. The porous media are placed in a trench formed within the aquifer generally parallel to the flow of ground water through the aquifer and down to the underlying bedrock. No mention of arsenic is made.

Alteration of aquifer chemistry by introduction of gases has usually been limited to air sparging. Air sparging alters the water transmission capacity of aquifers. The air injected during air sparging displaces water in intergranular spaces in the aquifer with air thereby inhibiting water flow. Sparging is unsuitable near production wells for this reason, reduction of the capacity of the aquifer to transmit water, and the potential of air entrainment into distribution systems or air-locking of pumps. Air sparging is unsuitable for removing arsenic from ground water because air sparging disrupts the ambient ground water flow. The ability of the aquifer to transport water is directly proportional to water-filled pore space. Air sparging displaces water with air, thereby inhibiting flow.

Hallberg et al. in U.S. Pat. No. 4,755,304 teaches the introduction of oxygen to aquifers by withdrawal, oxygenation and reinjection of water. Withdrawal, oxygenation and reinjection requires a substantial physical plant and substantial energy costs for pumping. Pumping efficiency can decline as pipes become clogged. The potential for near well fouling is greater using this method. When used for contaminant treatment by sorption to iron treatment residuals, withdrawal, oxygenation and reinjection can produce wastes that must be disposed of.

Introduction of oxygen to aquifers has also been accomplished in the past by injection of oxygen bearing or producing solutions and placement of oxygen producing solids (oxygen release compounds) in well bores. Methods that inject oxygenated fluids in wells disturb the ambient ground water flow. Fluids are forced on pathways not normally taken by ambient ground water flow. Introduction of fluids not in equilibrium with aquifer chemistry can have deleterious effects on aquifer chemistry and hydraulic conductivity. Methods that use solid-phase oxygen releasing compounds deployed in wells (below the water table) have the disadvantage that they add dissolved constituents to the ground water. These persistent dissolved constituents degrade ground water quality. Additionally, the oxygen release rates from solid phases are not constant and poorly predictable.

There continues to be a need for more cost-effective in situ treatment of ground water. And one that generates little or no waste, especially hazardous waste (e.g. arsenic).

### SUMMARY OF THE INVENTION

The present invention is novel and has the following advantages as compared with other methods of subsurface oxygenation, specifically.

Methods that inject oxygenated fluids into wells disturb the ambient ground water flow field. Fluids are forced on pathways not normally taken by ambient ground water flow. Introduction of fluids not in equilibrium with aquifer chemistry can have deleterious effects on aquifer chemistry and hydraulic conductivity. The present method creates the minimum disturbance in chemistry by oxygenating the ambient water. Other treatments that alter fluid chemistry either have to pump ground water to the surface to alter chemistry, or inject synthetic ground water to avoid undesirable reactions. Methods that use solid phase oxygen releasing compounds deployed in wells (below the water table) have the disadvantage that they add dissolved constituents to the ground water. These persistent dissolved constituents degrade ground water quality. This is as compared to introduction of only gasses, avoiding degradation of water quality by persistent chemicals. Dissolved gasses are generally consumed (not persistent) in the process of performing desirable reactions that improve ground water quality. Additionally the oxygen release rates from oxygen releasing compounds are not constant and are poorly predictable. Techniques such as “air sparging” that force air or other gasses into subsurface aquifer materials below the water table lowers the capacity of the near well materials to transmit water (lowered hydraulic conductivity). This limits the effectiveness of gas transfer and geochemical alteration of subsurface chemistry. The present method provides a means for altering ground water chemistry using dissolved gasses and to thereby provide a means for removing undesirable constituents such as Fe, Mn.

The preferred embodiment of this invention also includes a method of removing arsenic from ground water. The arsenic is removed by co-precipitation with iron and by adsorption onto FeOₓ surfaces.

One aspect of the invention is the placement of oxygen into in situ ground water with high iron and or manganese concentrations for treatment of iron and manganese. Another aspect of the invention is the placement of oxygen into in situ ground water with high iron concentrations for treatment of arsenic. Another aspect of the invention is placement of Fe²⁺ into ground water with low iron concentrations for treatment of arsenic. Another aspect of the invention is injection of Fe²⁺ into ground water through delivery of Fe²⁺ enriched water for treatment of arsenic. Another aspect of the invention is an apparatus which includes a mechanism to deliver O₂ into ground water for treatment of arsenic. Another aspect of the invention is an apparatus which includes a mechanism to deliver Fe²⁺ into ground water for treatment of arsenic. Another aspect of the invention is a system utilizing a mechanism to deliver O₂ into ground water for treatment of arsenic, iron and manganese and a controller that monitors and instructs. Another aspect of the invention is a system utilizing a mechanism to deliver Fe²⁺ into ground water for treatment of arsenic and a controller that monitors and instructs. Another aspect of the invention comprises the method of effectively treating a target substance, e.g. arsenic, in situ in the ground, e.g. relative to a production well, to reduce the target substance to an acceptable level, by sequestering or co-precipitating a sufficient amount of the target substance from ground water by addition of at least an amount of oxygen into the ground. Another aspect of the invention comprises the method of effectively treating a target substance, e.g. arsenic, in situ in the ground, e.g. relative to a production well, to reduce the target substance to an acceptable level, through addition of an effective amount of oxygen into the ground. Another aspect of the invention comprises the method of effectively treating a target substance, e.g. arsenic, in situ in the ground, e.g. relative to a production well, to reduce the target substance to an acceptable level, by addition of an effective amount of oxygen and/or another substance into the ground. Another aspect of the invention comprises a method of treating a target substance, e.g. arsenic, in situ in the ground, to reduce the target substance to an acceptable level, by effectively modeling the amount and manner of addition of a substance(s) into the ground to accomplish such treatment.

A still further aspect of the invention comprises a method of evaluating a candidate production well for treating a target substance, e.g. arsenic, in situ in the ground, to reduce the target substance to an acceptable level. Another aspect of the invention comprises a method of installing an apparatus to practice one of the foregoing methods. Another aspect of the invention comprises an apparatus to practice one of the foregoing methods. Another aspect of the invention comprises a method and apparatus to monitor performance of a method or apparatus of treating a target substance by one of the foregoing methods. Another aspect of the invention comprises a method and apparatus to control on-going operation of a foregoing method.

These and other aspects, objects, features, and advantages of the present invention will become more apparent with reference to the accompanying specification and claims.

### BRIEF DESCRIPTION OF THE DRAWINGS

FIG. 1 is a diagrammatic view of a method for in situ treatment for arsenic.

FIG. 2 is a diagrammatic view of a in situ iron, manganese and arsenic removal system.

FIG. 3 is a diagrammatic view of an alternate placement of wells for conditions that require added iron.

FIG. 4 is a diagrammatic view of a well configuration for introduction of air and iron for arsenic treatment.

FIG. 5 is a process flow diagram for an embodiment of the present invention.

FIG. 6 is a system design diagram as described further herein.

FIG. 7 is a diagram of well placement with respect to in situ arsenic removal rates

### DETAILED DESCRIPTION OF AN EXEMPLARY EMBODIMENT

In this detailed description, reference will frequently be made to the above-identified Figures. Reference numbers or letters will be used to indicate parts or locations in the Figures. The same reference numbers or letters will be used to indicate the same parts or locations throughout the drawings unless otherwise indicated.

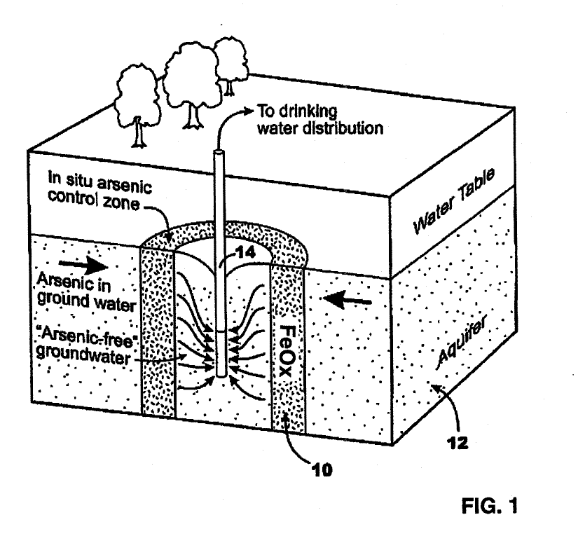

An exemplary method according to one aspect of the invention uses methods to create renewable subsurface barriers that remove arsenic. As shown in FIG. 1, one method creates what will be called a (FeOₓ) filter 10 in the aquifer 12 surrounding a production well 14. The filter 10 forms zones around the production well 14. Unlike above ground treatment technologies for arsenic, the present method does not produce an arsenic-laden solid or liquid waste stream requiring disposal.

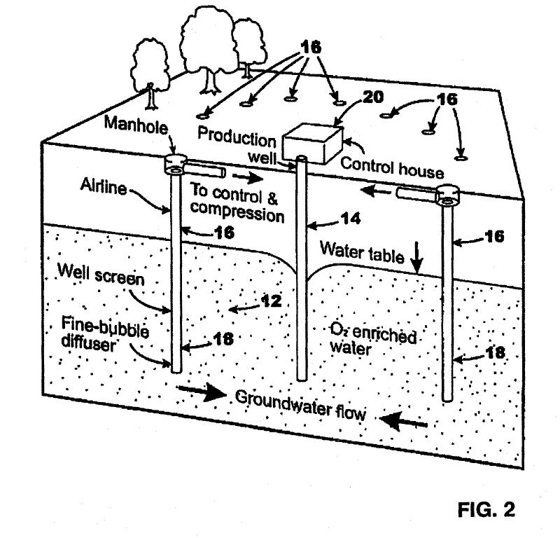

FIG. 2 illustrates one apparatus and system that could be used to set-up the filter of FIG. 1 in the ground. A compressor and a ring of oxygen-supplying aeration wells 16 are used to aerate the aquifer 12 around a production well 14 altering the near-well biogeochemistry of the aquifer 12. (Only 180° of the ring is illustrated in FIG. 2 for simplicity.) The compressor is preferably a continuous duty oil free compressor.

The system works as follows. FeOₓ exist naturally in regional aquifer sediments at varying concentrations. In aquifers, these FeOₓ adsorb dissolved arsenic, iron and other compounds on their surfaces. When dissolved oxygen (O₂) is flushed into these normally low-oxygen (<1.0 mg/L) aquifers there are several effects. O₂ causes sorbed and dissolved Fe²⁺ to oxidize to Fe³⁺. The net reaction is as follows:
2Fe²⁺+½O₂+2H⁺==>2Fe³⁺+H₂O

The Fe³⁺ reacts rapidly at pH>2 to form more solid iron oxyhydroxides by hydrolysis. The net reaction is as follows:
Fe³⁺+3H₂O==>Fe(OH)₃+3H⁺

The fresh FeOₓ co-precipitates with the arsenic species (typically H₂AsO₄⁻, HAsO₄²⁻ and H₃AsO₃⁰) or sorbs arsenic species via surface complexation mechanisms (ligand exchange and covalent bonding) onto the FeOₓ surfaces. (Mn metal oxides also participate in the sequestration of arsenic, but the chemistry is not as well understood as the exemplary As—Fe chemistry presented herein.) This produces a geomedia arsenic filter 10 (treatment zone) around the production well 14. The zone around the well is conditioned to remove arsenic from the pumped water. The solid phase iron hydroxide, Fe(OH)₃, is commonly known as amorphous iron hydroxide, ferrihydrite and hydrous ferric oxide. Other iron hydroxides also form, again dependent on pH and solubility relationships. Goethite (α-FeOOH), lepidocrocite (γ-FeOOH) and akaganite (β-FeOOH) are also stable phases that co-precipitate with and surface complex arsenic oxyanions.

Arsenic in ground water is normally found in two valence states, the reduced As³⁺ form and the oxidized As⁵⁺ form. The As³⁺ form has a lower affinity for surface complexation with hydrous metal oxides than the As⁵⁺ form. This makes it desirable to be able to oxidize the As³⁺ form. Dissolved oxygen has not been observed to directly oxidize As³⁺ to the As⁵⁺ state. However, dissolved oxygen in combination with Fe²⁺ or metal oxide surfaces has been observed to oxidize As³⁺ to As⁵⁺. The system will cause As³⁺ to be oxidized because of its dependence on oxygen-iron chemistry for desirable reactions.

In addition to arsenic removal, one of the benefits often seen with the application of the current invention is reduced plugging of the production well 14 and lower cost iron and manganese removal. This happens because hydrous metal oxide formation takes place at much greater distances from the production well 14 than the prior art. Also, in situ treatment is inherently less expensive than above ground treatment.

The dissolved oxygen introduced into the aquifer also stimulates aerobic microbial populations in the aquifer. Microbial populations are known to enhance the precipitation of iron and the sequestration of arsenic. This enhancement takes place by the following processes. Bacterial oxidation of Fe²⁺ to Fe³⁺ uses Fe²⁺ as an electron donor to cellular processes. This causes precipitation of FeOₓ at pH>2. These same reactions also cause the cell to release protons (H⁺) to the surrounding water. This pH drop increases the affinity of oxyanions for iron oxyhydroxides. Bacteria can free iron from its aqueous chelated forms, allowing precipitation to take place. The life cycle of iron bacteria provides the organic carbon for manganese bacteria to efficiently precipitate manganese solids. Bacteria can bring about the oxidation of As³⁺ to As⁵⁺. Some bacteria also gather iron oxyhydroxides colloids from water, causing them to form iron oxide coatings on aquifer materials (iron depositing bacteria). Bacterial sequestration of oxyanions also happens through complexation directly on the surface of bacteria.

The present invention promotes the minimum possible disturbance in chemistry by oxygenating the ambient water. Water in the well bore is oxygenated. The oxygenated water then advects and diffuses from the well bore, replaced by water from the upgradient direction.

Techniques such as “air sparging,” that force air and other gases into subsurface aquifer materials below the water table, lower the capacity of the near well materials to transmit water (lowered hydraulic conductivity). This limits the effectiveness of gas transfer and geochemical alteration of subsurface chemistry, in addition to providing a barrier to desirable ground water flow.

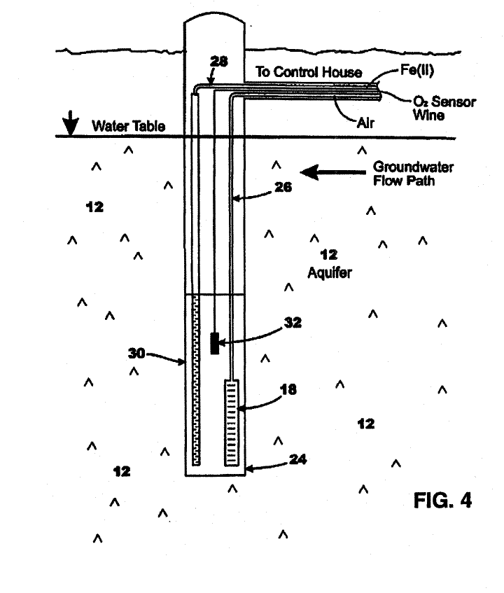

Alteration of water chemistry in the well bore can be accomplished by addition of a gas. As illustrated in FIGS. 1-5, and particularly FIGS. 2 and 4, one method of gas introduction is by use of fine pore diffusers 18 with injection wells 16. Diffusers 18 are fine pore aeration systems. Diffusers 18 are available commercially in a range of sizes and materials. The gas transfer physics and chemistry of diffusers 18 in aqueous systems are well known.

Diffusers 18 are installed in wells 16 of variable diameter based on need, spaced horizontally and vertically in a manner necessary to achieve the desired result. This spacing and number of wells 16 and diffusers 18 depends on the area to be treated, the ground water chemistry, the chemistry of the desired reaction, the hydraulic properties of the aquifer including the ground water flow field as perturbed by wells, gas-fluid transfer rates and reaction kinetics.

Diffusers 18 are deployed singly or plurally in wells 18 with gas transfer lines at the appropriate location (usually the bottom) in the well screen intervals. Diffusers 18 are operated with variable timing, alternating use, and variable gas delivery rate and pressure as needed to bring about the desired effect. Diffusers 18 are placed with centralized supports to keep the diffuser centered in the well bore, suspension support so the diffuser can be retrieved from the well, buoyancy compensation to counteract the buoyancy of the diffuser, and bubble flow diverters to effect mixing as needed. Diffusers 18 are operated using either a manual, timed or programmable gas delivery apparatus in the control house 20.

The above exemplary embodiment is by way of example and not limitation. The invention can take many forms and embodiments. Variations obvious to one skilled in the art are included within the invention.

Use of fine bubble gas diffusers 18 in wells creates water with a different chemistry than exists naturally in ground water. The gases injected can include air, oxygen, methane or carbon dioxide, depending on the reactions desired. Dissolved oxygen derived from air is the primary example herein, but the technology is not limited to this specific treatment option.

Methane can be used to cause reducing conditions and growth of certain microbes. Carbon dioxide can be used to alter alkalinity and pH. By increasing the dissolved oxygen level in ground water, undesirable contaminants such as iron, manganese, nitrite, ammonia, and organic carbon are also lowered in concentration. The reduction in concentration takes place because of inorganic and biologically mediated reactions.

Another aspect of the invention relates to system design, installation and monitoring of operation. Systems can be designed, installed and operated as follows. The treatment system design is adapted to each individual site. The design is engineered to account for reasonable variations in water quality and well hydraulics. It is based on site data. Investigations to ensure that all design factors are considered before installation are usually conducted.

One step could be to evaluate the hydrogeology and well hydraulics by performing a satisfactory pump test (12 hour step-test) to determine the transmissivity (T) and hydraulic conductivity (K) of the aquifer, and pre-installation well efficiency. It is necessary to research regional and local hydrogeology to determine if there are any design implications. Some infrastructure interference is expected during installation. The extent of this interference needs to be assessed before design and specifications can be finalized.

Another step could be to obtain a broad chemical analysis of a high-quality sample. It can be important to accurately determine oxidation demand to ensure appropriate installation. For example, a pre-chlorination sample is obtained during the pumping test. This will provide information on oxygen-consuming substances that may be present but not have been tested for previously. Also, this data verifies that chemistry that inhibits arsenic sorption has been adequately characterized. If critically adverse data is obtained at this early stage, the design can be enhanced, or an alternate technology can be selected for the site.

Installation can involve construction of aeration wells around the production well(s). In addition to the aeration wells, a properly sized, oil-free, continuous duty air compressor and programmable timer controls can be installed. The flow control panel and the air compressor can be small enough to fit easily into most existing pump houses. The aeration lines can be trenched to the aeration wells, leaving a very low profile.

Once the system is installed, a start-up phase can be used to optimize system operation. This can involve regulating the individual airflow to each of the aeration wells. Observation and geochemical modeling can determine the length of time per day that each aeration well is in operation. One parameter to consider usually is the length of time it will take for the system to rebound to arsenic concentrations greater than 10 ppb if there is a malfunction. Experience indicates that, in the case of total system incapacitation, delivered water will continue to meet treatment objectives for several days. The successful removal of arsenic, iron, and manganese will determine if there is a need for any additional manipulation of the system. This phase may take up to 3 to 4 weeks before the system is operating at or near the most efficient point. Efficiency can be evaluated by comparing compressor run duration (power consumption) to removal efficiency.

Many aquifers will contain iron concentrations that are too low to remove contaminants, such as arsenic, to desirable levels via sequestration with FeOₓ. In these cases it is possible to achieve the desired results by adding additional Fe²⁺ to the aquifer, removing it with the contaminant in the same manner as the previous exemplary method. The difference is that ambient iron concentrations are supplemented using wells to inject iron as Fe²⁺ into the aquifer.

Systems that require increased iron concentration over ambient require equipment to deliver the iron. Such equipment includes: tubing and orifices or screen for introduction of iron in aeration wells at selected intervals, or into additional iron injection wells. Provisions for inert gas use to strip O₂ from the water in air injection well casing during introduction of Fe²⁺ to prevent premature oxidation, metering pumps and mixing lines to use iron-free water produced at the central well as the dilution fluid for concentrated FeSO₄ solution (FeCl₂ or other inorganic salts of iron can be used but are not as desirable because of the relatively innocuous nature of FeSO₄).

The system works by utilizing aeration wells as iron injection points, creating a outer ring, wall or other configuration (farther away from the production well) of wells to use for iron injection, or a combination of these two methods.

The process sequence for aeration wells using combination air-iron wells is: turn off air to diffusers, switch to diffusion of inert gas (N₂) to strip O₂ from the water in the well casing, inject Fe²⁺ solution at the appropriate concentration and duration, allow time for the Fe²⁺+solution to move away from the injection point(s), resume injection of air.

The principle that makes this work is that the movement of Fe²⁺ in aquifers is retarded with respect to the movement of water, and the movement of O₂. Because O₂ moves faster) Fe³⁺, the O₂ will over run the Fe²⁺ causing oxidation of Fe²⁺ in water, and adsorbed to FeOₓ. The ability to add iron makes it possible to apply the system to a much broader set of problems than using ambient iron alone.

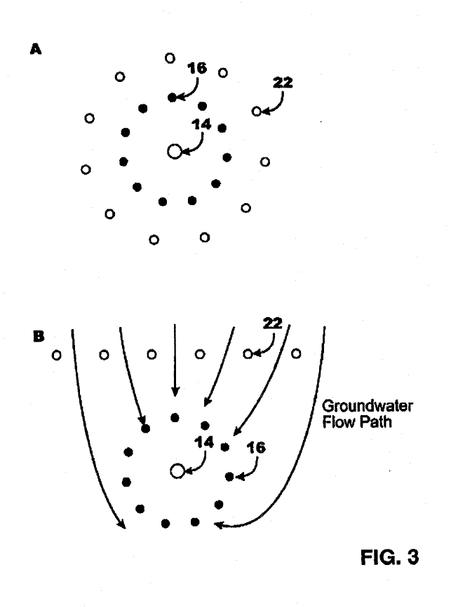

FIG. 3 depicts two examples of iron injection well configurations. The best configuration is dictated by site geochemistry, hydrology, and the cost of well placement alternatives. FIG. 3a depicts iron injection wells 22 radially arrayed around aeration wells 16 and the production well 14. FIG. 3b depicts a line of iron injection wells 22 that place iron solutions in the capture zone of a production well 14.

In both cases Fe²⁺ bearing solutions are mixed in the control house 20 using metering pumps, mixing lines, and to use water produced at the central well as the dilution fluid for concentrated FeSO₄ solution (FeCl₂ or other inorganic salts of iron can be used but are not as desirable because of the relatively innocuous nature of FeSO₄). Automated programmable controls are used to time injection of iron and regulate continuous and/or pulse concentrations of iron solution. The desirable chemistry is where the amount of added iron as Fe²⁺ is just sufficient to bring about the desired reaction.

In the configurations shown in FIG. 3, Fe²⁺ solutions are introduced to the aquifer in a geochemical zone that does not contain added O₂ from the aeration wells. The Fe²⁺ is not precipitated as beneficial FeOₓ until it passes within the zone of oxygen introduction. Due to design or cost factors it may not be possible to have a set of wells in addition to the aeration wells dedicated to iron injection. Under these conditions it will be necessary to inject Fe²⁺ solutions into the same wells that are used for air diffusers.

Aeration wells are designed to precipitate FeOₓ from Fe²⁺ in solution. Operating air diffusers while injecting Fe²⁺ solutions will bring about undesirable plugging of the aeration well. To bring about the desired introduction of Fe²⁺ without plugging the diffusers, iron injection and air diffusers can be operated in an alternating manner.

FIG. 4 depicts one physical configuration of a combination air diffuser and iron injection well. The well contains an air diffuser 18, supply line 26 and a screen 30 and a supply line for iron injection 28 that provides for iron solution emplacement within zones appropriate for the design. Alternately, a tube or pipe with orifices can be used to deliver iron solutions rather than a screen 30. Two modes of operation are envisioned here. In the first the air diffuser 18 is shut down by the controller and dissolved oxygen monitored by the dissolved oxygen sensor 32. When O₂ levels are low enough for iron injection, the iron solution is introduced through the iron solution screen 30 into the well screen 24. Alternately, a sensor can be used to monitor the changes in electrical conductivity of the water in the well 16 caused by introduction of iron solution, performing the same timing function as the dissolved oxygen sensor 32. After a time interval sufficient to allow the Fe²⁺ solution to advect away from the well screen 24, the air diffuser 18 is returned to operation and the O₂ concentration again rises.

In conditions where it is desirable to remove dissolved oxygen to below ambient concentrations prior to Fe²⁺ injection, or where dissolved oxygen concentrations do not drop off quickly enough for process chemistry concerns, the dissolved O₂ is stripped from the water by an inert gas such as argon or nitrogen. The sequence for the process using combination air-iron wells with inert gas is to turn off air to diffusers 18, switch to diffusion of inert gas to strip O₂ from the water in the well casing, inject Fe²⁺ solution at the appropriate concentration and duration, allow time for the Fe²⁺ solution to move away from the injection point(s), resume injection of air.

The principle that makes this work is that the movement of Fe²⁺ in aquifers is retarded with respect to the movement of water, and the movement of O₂. Because O₂ moves faster than Fe²⁺, the O₂ will over run the Fe²⁺ causing oxidation of Fe²⁺ in water, and adsorbed to FeOₓ. The ability to add iron makes it possible to apply the technology to a much broader set of problems than using ambient iron alone. The introduced iron cycles are optimized to achieve performance goals at minimal possible cost.

Determining if the disclosed technology is suitable for arsenic removal at a specific site requires answering three specific, and quantifiable, questions: Can FeOₓ be precipitated from the source water using O₂? Is there sufficient iron present to drop arsenic concentrations to below 10 ppb? Will the presence of interfering substances inhibit in situ arsenic removal to below 10 ppb?

The first question asks if a system can be engineered to deliver enough atmospheric oxygen to the subsurface to precipitate iron and manganese as FeOₓ. The design method involves calculations of the chemical and biological oxygen demands of the aquifer, aeration well gas transfer efficiency, the ground water velocity field around the production well, and how those variables change with time. These data are used for the evaluation of treatment technology for this site.

The second question is related to the central theme of removing arsenic by reaction with FeOₓ. This removal, completely analogous to above ground iron-arsenic treatment, requires FeOₓ to be present in sufficient concentration to sequester arsenic while overcoming adverse conditions caused by pH or the presence of competing ions. For the precipitation-coprecipitation example shown in FIG. 2, the EPA draft design manual for small systems suggests that the iron removal should be achieving satisfactory arsenic removal by oxidation if: the Fe:As mass ratio is greater than 20:1; and total Fe concentration is greater than 1.5 milligrams per liter (mg/L). If the site water chemistry meets these conditions, arsenic removal by subsurface oxidation of iron should be successful.

Conservative geochemical modeling is one way to assess whether the system will be effective at a particular site without conducting a full-scale demonstration. It is this effort that can answer the third question. Using all relevant data, geochemical modeling can determine if the formation of FeOₓ from the available reduced iron in the aquifer is sufficient to remove arsenic. It also can determine if interfering chemicals such as phosphate and silica will impede arsenic sorption to the point where the technology will not achieve the MCL.

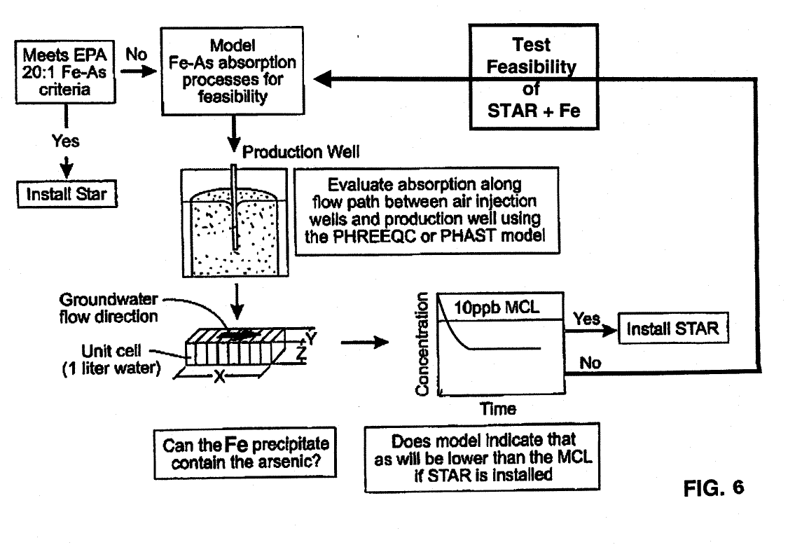

Reactive transport modeling provides the answers to many design questions. The mobility of metals in the environment is very complex and controlled by a large number of competitive biogeochemical processes. These biogeochemical processes depend on the concentration and availability of chemicals that participate in the biogeochemical reactions. Because chemical concentration is controlled in part by ground water flow processes, modeling these processes many times needs consideration of both flow and chemistry. Ground water flow models that take into account flow, chemistry, and the interactions between the two are called reactive transport models. If all of the significant processes are well accounted for, reactive transport models of the sequestration of arsenic by FeOₓ can provide answers regarding the viability and efficiency of the process at a specific well. The United States Geological Survey reactive transport computer codes PHREEQC and PHA ST can be used to design treatment systems. These codes are publicly available. FIG. 6 depicts the modeling process used, as applied to the design of an in situ arsenic treatment system using ambient aquifer iron concentrations.

To conduct the evaluation, a kinetically limited model is used to determine the dissolved oxygen required to oxidize the design rate and mass of Fe²⁺ delivered to the system. The dissolved oxygen must be sufficient to cause the desired iron oxidation, oxidation of organic mater and chemical oxygen demand, and support development of an aerobic microbiological community in the subsurface. The chemical modeling must take into account the iron oxide formation rates, concentration of contaminant to be removed, time and spatially variable pH, redox potential, dissolved oxygen kinetics, microbial mediated reactions, competitive sorption reactions, hydrologic properties of the well and aquifer, usage patterns and demand, and the manner of addition of excess Fe²⁺ over ambient concentration, if desirable. The process is iterative, adjusting injection well placement, size, air and iron addition rates, and timing. It is preferable to design an in situ system with consideration of all of these factors.

It is believed that arsenic is sequestered in the subsurface by three classes of reactions. These include surface complexation at the FeOₓ surface, co-precipitation of arsenic with the FeOₓ as they form, and biogeochemical (bacterial) surface complexation and FeOₓ precipitation. Inorganic surface complexation is well understood in the art and can be modeled with a high degree of accuracy. The other two processes can also be modeled, but with a degree of uncertainty. To maintain a conservative approach, we model the removal of arsenic by co-precipitation or biogeochemical pathways in a limited manner. If the surface complexation models alone predict arsenic removal to below the 0.010 mg/L MCL is possible, the modeling indicates that the method is successful. The other biologically mediated processes will account for the removal of additional arsenic beyond what is predicted by surface complexation modeling ensuring a conservative approach.

There are relatively large numbers of computer codes designed to simulate aqueous geochemistry and water-rock interaction using thermodynamics. In most cases, the codes have been shown to be capable of providing a realistic representation of equilibrium solution chemistry processes, including the surface complexation of trace elements, such as arsenic. These codes have 20 years of historical application to real-world problems.

The constraints placed on physical design and chemical demands of reactions by near-well flow velocities are significant (the Darcy velocity of water in an aquifer is greatly increased near a pumping well). These relationships, between kinetically limited reactions and transport rates, are Damkohler relationships.

As water nears a production well, its velocity increases. We want to alter the chemistry of the water as it nears the well, changing the chemical equilibrium between dissolved and adsorbed arsenic. There are many biogeochemical processes that will take place in the region between an oxygen aeration well and the production well. Each of these processes (e.g., hydrodynamic dispersion, diffusion, pH effects, cellular metabolism) is associated with a reaction rate. Most of these rates involve surfaces and solids and so are dependent on the water contact time. Above a certain characteristic velocity, the chemistry of the water will not reach the required degree of chemical equilibrium with the solid aquifer materials (biomedia and geomedia) necessary to reduce arsenic concentrations below 10 ppb, the recommended maximum under current EPA published regulations. Below that velocity, biogeochemical reactions with geomedia have enough time to influence water chemistry.

Together, the characteristic fluid velocity, the distance between wells, and the arsenic removal rate describe a Damkohler number, a term used to define transport velocity limited reactions, chemical rate limited reactions, and the transition between them. Damkohler numbers (D) are determined using the following relationship:

$$D = \frac{reaction rate X characteristic length}{fluid velocity}$$

and are dimensionless. Larger Damkohler numbers indicate systems closer to biogeochemical equilibrium than smaller numbers. Using units of meters and seconds, Damkohler numbers of >100 indicate local chemical equilibrium is probable (Appelo and Postma, 1996). An important practical implication of the Damkohler formula is that if the chemical principles that we rely upon for arsenic removal are sound, then equilibrium removal of arsenic to below 10 ppb could always be reached if the flowpath is long enough. However, cost and practicality make minimal flowpath length and diffuser discharge rates necessary. In short, Damkohler numbers should be large enough, but not too large.

In a homogeneous aquifer with a perfect well, it is believed that a circular array of oxygen aeration wells (far enough from the well to provide overlap of the oxygen plumes) would cause the desired effect if the distance is great enough and the overall arsenic removal rate fast enough. Subsurface iron treatment experience indicates that the characteristic lengths (distance between aeration wells and the production well) are on the order of 15-50 feet from the intake well screen for large capacity wells.

The velocity distribution is usually dependent on aquifer properties such as porosity and hydraulic conductivities, which are generally heterogeneous, and pumping rate, which can be highly variable. The result is that the characteristic lengths and velocities will vary based on its distance from the production well and pumping conditions. Given the previous discussion of aquifer heterogeneity (spatially variable fluid velocity) and its effect on radial flow, it can be assumed that uniformly spaced configurations will rarely be optimal. In fact, a hypothetical surface constructed about the production well in a manner coinciding with the termination of all characteristic lengths should be expected to be quite irregular.

Therefore, an issue becomes, how can characteristic lengths (a surrogate for cost and performance) be optimized? Wells placed too close will not be able to fully control arsenic as they will be inside the characteristic length needed for arsenic removal. Our approach is to use the Damkohler relationship to optimize the trade-off among controllable parameters. There are at least four parameters we can adjust: number of aeration wells, the radial distance, the amount of oxygen introduced and the quantity of Fe²⁺ to be added to the aquifer. In an experimental setting, we also usually have control over the pumping rate. Because past experience with iron removal correlates with arsenic treatment, it is possible to design well spacing, well number, and screen length based on hydrogeologic conditions at the site. Aquifer heterogeneities usually will not be known until after installation of the aeration wells. That leaves oxygen diffusion rate as the primary adjustable parameter following system installation.

Here we extend the Damkohler concept, from point values to a surface. We define a Damkohler Surface as a physical representation of all possible orientations of characteristic lengths for a specific reaction rate around the production well. The physical space that is inclusive of all reaction rates of interest, thereby inclusive of all Damkohler Surfaces, is the Damkohler Field and applies to the total arsenic removal rate. We consider oxygen dispersivity, and Fe²⁺—O₂ reaction kinetics as rates. Oxygen plumes must overlap for the reaction volume to be completely treated. There is a minimum volume of aquifer material needed to remove arsenic to the desired concentration at the maximum production well discharge. Treating more than this volume is usually unnecessary and costly. With a known Damkohler number, the characteristic velocity could be reached at some characteristic length (distance) from the production well.

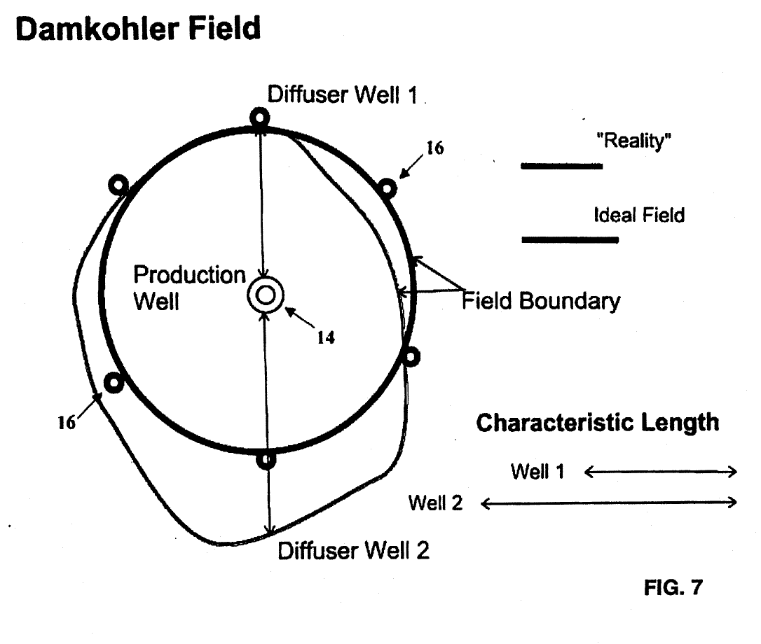

The thin line around the production well 14 in FIG. 7 represents a hypothetical Damkohler Field at some depth below ground surface. Shorter characteristic well lengths occur along flow tubes where ground water moves more slowly, because a greater reaction time is allowed. Well placement cannot be optimized for heterogeneities without detailed hydrogeologic data. Diffuser or aeration Well 2 (ref. no. 16) is inside the surface. The black line represents a ‘perfect’ optimization. If the amount of arsenic that is to be treated is high or the production volume is large, long characteristic lengths will result because more surface area is required. Shorter characteristic lengths are more desirable because they minimize the cost of system installation by reducing the number of wells needed to cover the radii of the Damkohler Field with oxygenated water. Quantification of Damkohler concepts allows predictions of performance, reduction of cost, and a diagnostic approach to design, implementation, and troubleshooting.

If a diffusion well is located inside the Damkohler field, arsenic will not likely be fully removed and the well will not fully contribute to its removal (See Diffuser or aeration Well 2 (ref. no. 16) and thin line in FIG. 7). The Damkohler surface should be positioned so that it results in treatment of the minimum necessary volume plus a safety factor. By optimizing the oxygen delivery, costs are minimized (thick line in FIG. 7). Overall system performance can depend upon average flow-weighted and arsenic reduction-weighted performance of treatment wells. The physical and geochemical processes affecting treatment well performance vary over time. Therefore, treatment performance of the system will vary over time. In a dynamic system, some flow-fields (flow lines encompassing the wedge of aquifer material extending from the production well to the area around an individual aeration well) may protect water beyond drinking standards while other flow fields may allow water exceeding standards to pass to the well.

Successful in situ treatment of iron and manganese using O₂ is a much less complex process than treatment of arsenic using O₂. This is because in situ arsenic treatment must consider all factors necessary for iron treatment and all of the complex geochemistry of arsenic. Achieving iron control does not in any way guarantee arsenic control. In situ iron and manganese removal technology based on increasing the level of O₂ in the subsurface are designed using very few variables. Iron system designs must take into account only the amount of O₂ required, the time needed for the reaction to take place (governed by well known iron oxidation kinetics), and the required minimum distance from the production well for aeration wells that allows the reaction to proceed to completion (governed by well hydraulics). Arsenic treatment uses these factors as a minimum starting point for evaluation of arsenic-iron interaction.

The ability of O₂ to treat arsenic in ground water is limited by the concentration of Fe²⁺ and FeOₓ available and the aspects of the water chemistry that determine FeOₓ ability to adsorb arsenic. Analysis and engineering must be conducted with great rigor and public confidence because arsenic is a known human carcinogen. The deleterious effect of iron is limited to poor taste and staining of clothing and plumbing fixtures. In situ iron system design is unconcerned about the nature and quantity of the FeOₓ produced by O₂ addition, as long as the Fe²⁺ is removed. For arsenic, these factors are critical. The only feasible way to evaluate these complications is to model the geochemical behavior of the arsenic treatment system, before installing the system, using reactive transport flow and chemistry computerized simulations. Because human health is involved the practitioner must use design methods that are transparent to regulatory agencies, and be skilled in their use. In situ iron treatment saves money, in situ arsenic treatment does that, in addition to saving lives. The required level of rigor in design of one cannot be compared to the other.

As can be appreciated, variations obvious to those skilled in the art are included in all aspects of the invention.

Different delivery methods and mechanisms can be used to introduce substances to in situ ground water. For example O₂ (or other gas) could be delivered in any phase (gaseous, liquid, solid). It could be included in a carrier (e.g. H₂O). Other ways are possible.

Iron, manganese and arsenic are leading candidates for treatment by the invention. Other substances can also be targeted, either singly or concurrently.

While optimization of treatment is usually preferable, a variety of factors determine what is optimal. For example, meeting regulatory standards can be a goal. Many times persons skilled in the art can adapt a method or system towards that goal using their skill to select between choices. Furthermore, sometimes things such as cost of design, implementation, operation and maintenance, as well as other practicalities in this field of endeavor, form a part of what is considered optimal for a given circumstance.

As can be further appreciated, the present invention provides for methods, apparatus, and systems to deal with competing reactions in most in situ ground water to attempt to effectively treat ground water in situ for arsenic and possible other impurities.

Additional information and details regarding possible exemplary embodiments of the invention are shown below. FIG. 6 provides diagrammatic illustrations of aspects of the invention. References to “STAR” and “STAR+Fe” are shorthand terms for (a) the general method of removing arsenic from ground water and (b) that method with the additional step of adding iron into the ground, respectively, as both described herein.

FIGS. 1-5 are STAR and STAR+Fe treatment system schematic. The amount of iron available for sequestration of oxyanions can be no greater than the flux of iron that moves past the ring of aeration wells to the production well. Some aquifers have high dissolved iron (>1.0 mg/L), some have undetectable iron. If iron in the ferrous state (Fe²⁺) is introduced outside the ring, or coincident with the aeration wells, the amount of iron available for treatment of oxyanions can be greatly increased. The system is designed to remove natural and added Fe²⁺ before it reaches the production well.

STAR systems have a ring of aeration wells that release oxygen into ground water. Air wells surround the production well. Introduction of oxygen into an aquifer causes a zone of biogeochemical iron and manganese precipitation. Arsenic is incorporated into the solids by biologically mediated coprecipitation, surface complexation with biosolids, and coprecipitation and surface complexation with hydrous metal oxides formed by oxygen-stimulated inorganic reactions.

As shown in the FIG. 6, STAR creates a filter in the aquifer that uses iron-dependent chemical reactions, i.e. adsorption of arsenic onto FeOₓ. Arsenic is removed from water by either co-precipitation with FeOₓ, or sorption to FeOₓ via a surface complexation process.

STAR+Fe will have a market niche for all wells where STAR cannot be used because of low iron concentrations, high arsenic concentrations, or competing species that overwhelm the arsenic or perchlorate removal potential of STAR systems without added Fe. The use of STAR+Fe technology has the potential to greatly impact how water utilities comply with the new arsenic rule and the emerging contaminant, perchlorate.

STAR and STAR+Fe should be able to be simulated by an ionic speciation and surface complexation reactive transport model. Using known and published thermodynamic and kinetic data to simulate the observations made of the model well-aquifer system will increase the success of commercialization. A successful and transferable model is a fundamental tool that is needed for design and deployment of the technology.

The global objective is to be able to mix waters representing contaminated and induced chemical conditions in a simulated near-well environment and observe the chemical changes that take place. Ideally, these chemical changes will result in the permanent fixation of arsenic, iron and manganese in the subsurface. Interpretation of results requires experiments where only one or two variables are changed at a time and results are reproducible.

The STAR process is relatively simple. Aeration wells are radially deployed around production wells to alter the near-well biogeochemistry of the aquifer. The process relies upon the oxygen in air-saturated water to biogeochemically precipitate FeOₓ on aquifer materials. Dissolved arsenic in the ground water is then adsorbed by FeOₓ on aquifer materials and further sequestered by biologic reactions. In addition to arsenic removal, one of the benefits often seen with the application of the technology is reduced plugging of the production well, and lower cost iron and manganese removal. This happens because FeOₓ formation takes place at much greater distances from the production well than would be the case without STAR. Because installation of all air-injection wells is required for STAR operation, bench-to-pilot scale testing of STAR technology is not feasible. Therefore, every installation must be based on the use of well-defined geochemical models to ensure that subsurface FeOₓ formation will be sufficient to drop observed arsenic levels to below the arsenic MCL. At sites where naturally occurring FeOₓ formation is insufficient, it is possible to inject additional iron into the subsurface to bring about the required FeO.sub.x formation for arsenic removal. However, this demonstration is intended to be limited to sites with the greatest potential for success with aeration treatment only.

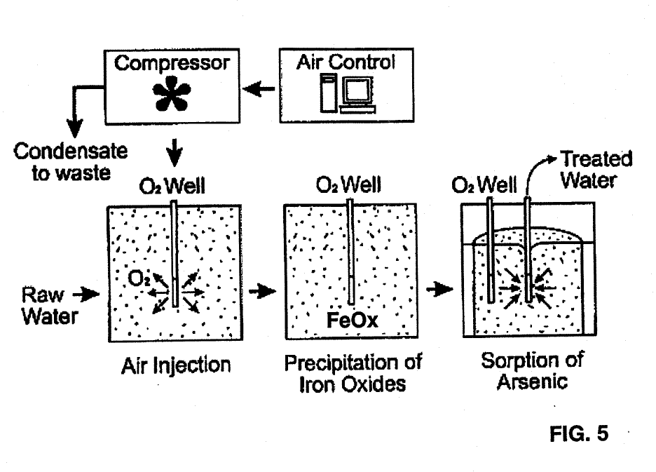

The process flow (see FIG. 5) for STAR is based upon creating, or reacting with, arsenic-complexing FeOₓ. STAR uses an oxidant, atmospheric oxygen, and the reagent is the ferrous iron already present in the ground water.

One major difference with STAR is that the arsenic-iron precipitates do not become a waste stream requiring disposal because all of the STAR ‘process’ steps occur in the subsurface.

1. A method for modifying ground water chemistry in an aquifer comprising the steps of
a) adding an oxygen-containing gas into at least one aeration well by diffusion, wherein said oxygen-containing gas becomes fully dissolved in said aeration well, and wherein said aeration well operates independently of any other aerations wells; and
b) modifying the ground chemistry by advection, diffusion, and dispersion of the fully dissolved oxygen-containing gas into said aquifer.

2. The method of claim 1, wherein the oxygen-containing gas addition is made through aeration wells around a production well.

3. The method of claim 1, where said aeration wells are equipped with a well screen and diffusers for adding the oxygen-containing gas.

4. The method of claim 1, wherein the aeration wells are located at a distance “upstream” from the production well such that modification of ground water chemistry can occur and deleterious effects on a hydraulic capacity of the aquifer are minimized.

5. The method of claim 1, wherein the aeration wells are located at such a distance from the production well that desirable reactions do not decrease the hydraulic capacity at the production well.

6. The method of claim 1, wherein the aeration wells are located to achieve modification of ground water chemistry in such a location and direction from the production well so that the required water quality is achieved.

7. The method of claim 2, comprising using fine bubble diffusers in the aeration wells to bring about desirable reactions.

8. The method of claim 1, wherein there is a reduction of the level of iron, arsenic, and/or manganese in the ground water of the aquifer.

9. A method according to claim 1, comprising sequestering or coprecipitating an amount of a target substance from the ground water.

10. A system for delivering an oxygen-containing gas to ground water comprising independently operating aeration wells around at least one production well wherein the aeration well comprises a means for delivery of the oxygen-containing gas to an aquifer in a fully dissolved form.

11. The system of claim 10, wherein the oxygen-containing gas is injected by fine pore diffusers.

12. The system of claim 10 further comprising a controller to monitor gas delivery and to control gas delivery.

13. A method for modifying ground water chemistry in an aquifer comprising the steps of a) stripping an area of the aquifer of oxidative gases with an inert gas wherein gas delivery is diffusion; b) adding Fe⁺² into the aquifer; and c) delivering an oxygen containing gas wherein the gas delivery is by diffusion.

14. A method of claim 13, wherein Fe⁺² addition is made through delivery wells separate from aeration wells used for gas delivery.

15. A method of claim 13, wherein Fe⁺² addition is made through aeration wells.

16. A method according to claim 9, wherein said target substances comprise iron, arsenic, or manganese.
